(19) United States
(12) Patent Application Publication
(10) Pub. No.: US 2011/0298889 A1
(43) Pub. Date: Dec. 8, 2011

(54) Administration method of lumber

(76) Inventor: Koichiro Seto, Oita (JP)

(21) Appl. No.: 13/006,635

(22) Filed: Jan. 14, 2011

Related U.S. Application Data
(63) Continuation of application No. PCT/JP2009/062987, filed on Jul. 17, 2009.

(30) Foreign Application Priority Data
Jul. 18, 2008 (JP) 2008-187668

(51) Int. Cl. H04N 13/00

(52) U.S. Cl. 348/42; 348/E13.074

(57) ABSTRACT

In an administration method of a lumber, an outer appearance of a lumber is photographed to obtain an image data, and a three-dimensional coordinate model of the lumber is created from the image data. Then, a minimum diameter and a length of the lumber are obtained from the three-dimensional coordinate model to calculate a mass volume of the lumber. Further, an edge surface pattern appearing on an edge surface of the lumber is extracted from the image data. After various processes are applied to the lumber, an edge surface pattern is recorded to create an edge surface pattern data. A history data, in which histories of the various processes are accumulated, and the edge surface pattern data are correlated and recorded, is constructed. Accordingly, when the edge surface pattern is compared with the edge surface pattern data, it is possible to trace the histories of the various processes.

### CROSS-REFERENCE TO RELATED APPLICATIONS

This is a continuation application of the prior PCT application PCT/JP2009/62987, filed on Jul. 17, 2009, pending, which claims priority from a Japanese patent application No. 2008-187668, filed on Jul. 18, 2008, the entire content of which is incorporated herein by reference.

### BACKGROUND OF THE INVENTION AND RELATED ART STATEMENT

The present invention relates to an administration method of a lumber. In particular, the present invention relates to an administration method of a lumber, in which a lumber is photographed to obtain image data thereof when the lumber is carried on a transportation vehicle or the lumber is carried out from the transportation vehicle, and a mass volume of the lumber is determined from the image data to streamline a transaction of the lumber. Further, in the administration method of the lumber, it is possible to trace and investigate a history of various processes applied to the lumber.

In general, after a lumber is cut in a field, a truck carries the lumber to a lumber factory or a sewing mill to be processed. A price of the lumber is determined according to a detailed agricultural standard, and is basically calculated by multiplying a volume of the lumber (referred to as a mass volume with a unit of cubic meter) by a price per cubic meter. The volume of the lumber is calculated by multiplying a length of the lumber by square of a diameter of a cut section of the lumber.

In general, the cut section of the lumber at a trunk root thereof (a root side) has a diameter different from that of a distal end of the lumber (a distal end side). Further, the cut section does not have a uniform shape.

As described above, when the price of the lumber is calculated, it is necessary to measure a minimum diameter of the lumber on the distal end side. In the past, an operator uses a hand scale to manually measure the minimum diameter of the lumber on the distal end side.

The lumber is a natural object, and the trunk thereof tends to be distorted due to various factors. To this end, Japanese agricultural standard stipulates which part of the cut section of the lumber is measured to determine the minimum diameter of the lumber. In reality, the operator has to accumulate experience and training to adequately determine the minimum diameter of the lumber.

Further, it is necessary to standardize the measurement results, in which any operator obtains the same result. Otherwise, it is necessary for a buyer of the lumber to verify the mass volume measurement result of a seller. As a result, it is difficult to transact a large volume of the lumbers.

Accordingly, in order to efficiently conduct the transaction of the lumber, it is necessary to guarantee objectivity of the mass volume measurement result, and to come up with a standard scale acceptable to both the seller and the buyer of the lumber. It is obviously imperative for the standard scale to eliminate human factors as much as possible, so that anyone on the seller side and the buyer side can obtain the same result.

Patent Reference No. 1 has disclosed a lumber selection device. The lumber selection device includes a photograph shooting unit for shooting a photograph of a cut section of a lumber carried in with a dark color background, an image processing unit for performing an image processing including a specific step based on an image of the photograph shot with the photograph shooting unit, and a transportation position changing unit for changing a transportation position of the lumber according to a lumber diameter determined with the image processing unit.

### Patent Reference No. 1: Japanese Patent Publication No. 06-55142

In recent years, in order to secure the safety and improve the reliability of a processed product such as food, the traceability has drawn attention. With the traceability, it is possible to trace and investigate a production location of a raw material, or a processed time and a processed place of the processed product.

The traceability has been important not only for food but for the lumber. When it is possible to trace and investigate a cutting location of the lumber, or a processed time and a processed place of a processed product of the lumber, it is possible to secure the safety of a wood product such as house and furniture, thereby improving reliability of the wood product. Further, when the cutting location of the lumber is specified, it is possible to prove that the lumber is cut in a vacant lot where woods are legally reproduced.

Accordingly, in the past, with respect to the traceability of the lumber, similar to food, a barcode or an IC tag is attached to the lumber, so that it is possible to trace and investigate the various processes such as drying and machining applied to the lumber.

Although it is still a conceptual idea, an annual growth ring of the lumber after being cut is recorded, and the annual growth ring thus recorded is compared to an annual growth ring of the lumber in a current state, so that the lumber can be identified (for example, refer to Patent Reference No. 2).

### Patent Reference No. 2: Japanese Patent Publication No. 2007-210119

In the case of lumber, it is possible to identify an outer contour of the cut section of the lumber to some extent with a two-dimensional image processed through a binarization process. However, the cut section of the lumber tends to be affected by an irregular pattern of the annual growth ring depending on a growth condition, soil stain, snow, or a slant cutting of the cut section. Accordingly, it is difficult to accurately identify the outer contour of the cut section of the lumber only through a color difference.

Further, in the case of the lumber, significantly different from the case of food, a processing step, in which the lumber is dried naturally outside, is performed after the lumber is cut before the lumber is used in a house or furniture. When the lumber is dried naturally outside, the barcode or the IC tag may fall off or be damaged due to wind and rain. Accordingly, it is difficult to trace the lumber with the barcode or the IC tag unlike the case of food. Further, when the lumber is dried naturally outside, the lumber tends to shrink to a large extent. Accordingly, the annual growth ring tends to have different patterns before and after the drying. As a result, the annual growth ring of the lumber just after the cutting is significantly different from the annual growth ring of the lumber in the current state, thereby making it extremely difficult to identify the lumber.

In view of the problems described above, an object of the present invention is to provide an administration method of lumber capable of solving the problems of the conventional administration method of lumber.

### SUMMARY OF THE INVENTION

In order to attain the objects described above, in an administration method of a lumber according to the present invention, an outer appearance of a lumber is photographed to obtain an image data, and a three-dimensional coordinate model of the lumber is created from the image data. Then, a minimum diameter and a length of the lumber are obtained from the three-dimensional coordinate model to calculate a mass volume of the lumber.

In the administration method of the lumber according to the present invention, the lumber may be photographed to obtain the image data when a rotational grapple provided in a transportation vehicle grapples and rotates the lumber to carry the lumber in the transportation vehicle or unload the lumber from the transportation vehicle.

In the administration method of the lumber according to the present invention, an edge surface pattern appearing on an edge surface of the lumber may be extracted from the image data. Then, after various processes are applied to the lumber, an edge surface pattern appearing on the edge surface of the lumber is recorded to create an edge surface pattern data. Then, a history data, in which histories of the various processes applied to the lumber are accumulated, and the edge surface pattern data are correlated and recorded, is constructed. Accordingly, when the edge surface pattern appearing on the edge surface of the lumber is compared with the edge surface pattern data, it is possible to trace the histories of the various processes applied to the lumber.

In the administration method of the lumber according to the present invention, an annual growth ring of the edge surface of the lumber may be used as the edge surface pattern.

As described above, in the administration method of the lumber according to the present invention, the outer appearance of the lumber is photographed to obtain the image data, and the three-dimensional coordinate model of the lumber is created from the image data. Then, the minimum diameter and the length of the lumber are obtained from the three-dimensional coordinate model to calculate the mass volume of the lumber. Accordingly, when anyone on a seller side and a buyer side measures the mass volume of the lumber, it is possible to obtain the same result, thereby making it possible to establish a standard scale of the mass volume measurement.

Further, in the administration method of the lumber according to the present invention, the lumber may be photographed to obtain the image data when the rotational grapple provided in the transportation vehicle grapples and rotates the lumber to carry the lumber in the transportation vehicle or unload the lumber from the transportation vehicle. Accordingly, the mass volume of the lumber is measured when the lumber is carried in the transportation vehicle or unloaded from the transportation vehicle. As a result, when the loading and unloading operation of the lumber is complete, the mass volume measurement of the lumber is complete, thereby improving efficiency of a transaction of the lumber.

Further, in the administration method of the lumber according to the present invention, the edge surface pattern appearing on the edge surface of the lumber may be extracted from the image data. Then, after the various processes are applied to the lumber, the edge surface pattern appearing on the edge surface of the lumber is recorded to create the edge surface pattern data. Then, the history data, in which the histories of the various processes applied to the lumber are accumulated, and the edge surface pattern data are correlated and recorded, is constructed. Accordingly, when the edge surface pattern appearing on the edge surface of the lumber is compared with the edge surface pattern data, it is possible to trace the histories of the various processes applied to the lumber. As a result, even when the lumber is naturally dried outside after being cut, the edge surface pattern of the lumber does not fall off or is not damaged like a barcode or an IC tag. Further, it is possible to compare the edge surface pattern data containing the edge surface pattern after the drying process. Accordingly, it is possible to securely trace and investigate the lumber.

Further, in the administration method of the lumber according to the present invention, the annual growth ring of the edge surface of the lumber may be used as the edge surface pattern. The annual growth ring of the edge surface is a pattern specific to the lumber, and cannot be manipulated artificially. Accordingly, it is possible to improve reliability of tracing and investigation of the lumber.

### BRIEF DESCRIPTION OF THE DRAWINGS

FIG. 1 is a schematic view showing a configuration of an administration method of a lumber according to an embodiment of the present invention;

FIG. 2 is a schematic view showing a configuration of an image processing apparatus of an image data in the administration method of the lumber according to the embodiment of the present invention;

FIG. 3 is a flow chart showing a sequence of calculating a mass volume of the lumber from a three-dimensional coordinate model according to the first embodiment of the present invention;

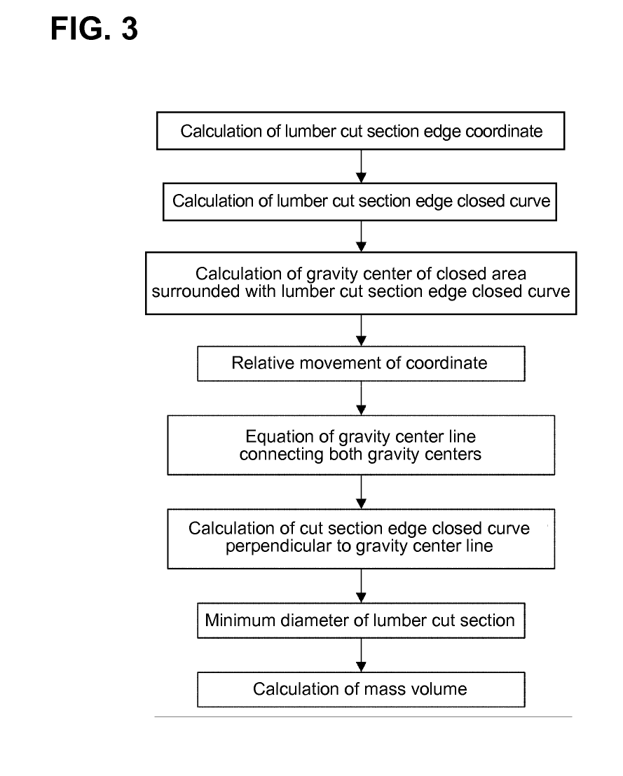

FIGS. 4(A) and 4(B) are schematic views showing a process No. 1 of the administration method of the lumber according to the embodiment of the present invention;

FIGS. 5(A) to 5(F) are schematic views showing a process No. 2 of the administration method of the lumber according to the embodiment of the present invention;

FIG. 6 is a flow chart showing a process to be applied to the lumber;

FIG. 7 is a schematic view showing a trace data in the administration method of the lumber according to the embodiment of the present invention; and

FIG. 8 is a schematic view showing an edge surface pattern data in the administration method of the lumber according to the embodiment of the present invention.

### DETAILED DESCRIPTION OF PREFERRED EMBODIMENTS

Hereunder, according to an embodiment of the present invention, an administration method of a lumber will be explained with reference to the accompanying drawings.

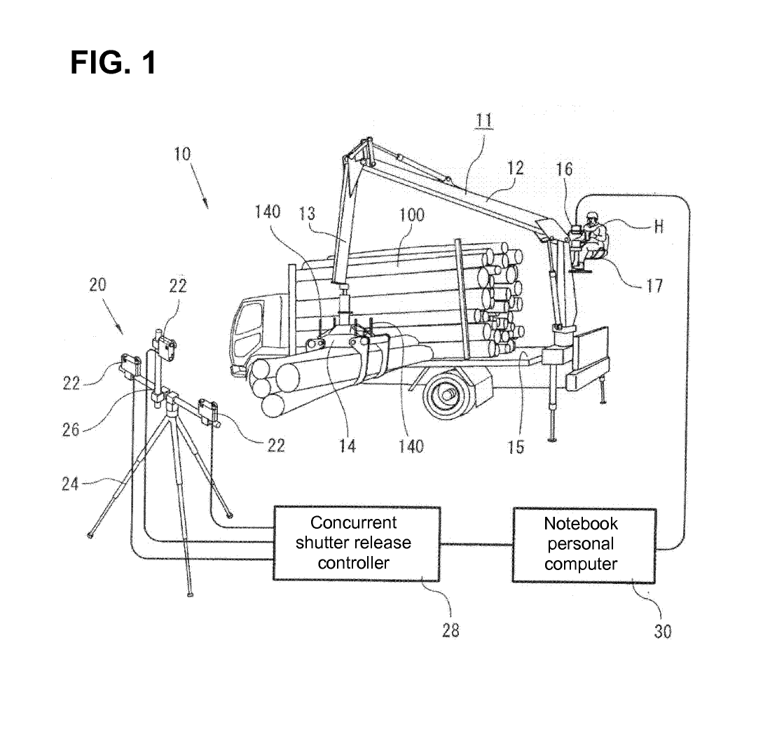

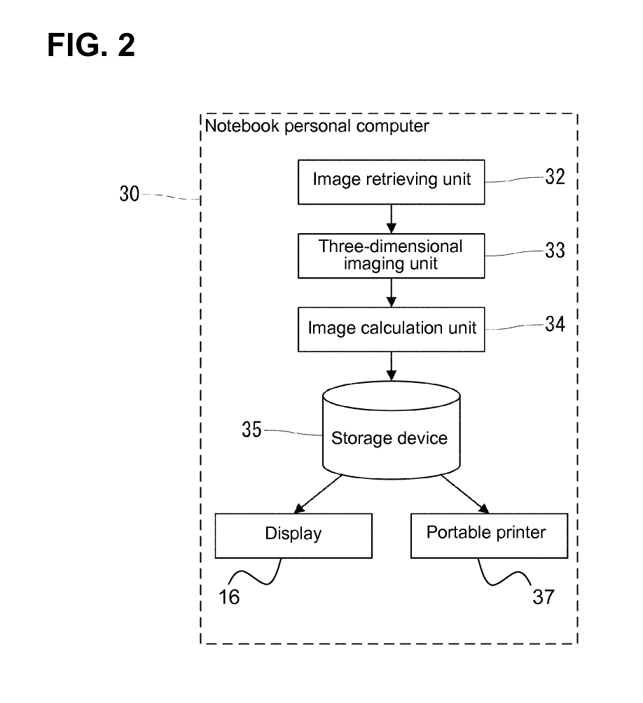

As shown in FIGS. 1 and 2, in the administration method of the lumber, there are provided a lumber transportation vehicle 10 provided with a rotational grapple 14 for carrying and unloading a lumber 100; an imaging device 20 of the lumber; an imaging status confirmation device 16 for an operator H operating the rotational grapple 14 to confirm an imaging status of the lumber to be photographed with the imaging device 20; and a computer 30 having a mass volume calculation unit for calculating a mass volume of the lumber 100 through image processing an image data of the lumber photographed with the imaging device 20.

After the imaging device 20 photographs the lumber 100 to generate the image data, the computer 30 performs the image processing on the image data. Through the sequence, when anyone on the seller side and the buyer side measures the mass volume of the lumber, it is possible to obtain the same result substantially. Accordingly, it is possible to functions as a standard scale between the buyer and the seller.

After the imaging device 20 photographs the lumber 100, the image data is transferred to the computer 30. Then, in the computer 30, an image retrieving unit 32 retrieves the image data. After the image retrieving unit 32 of the computer 30 retrieves the image data, a three-dimensional imaging unit 33 converts the image data thus retrieved to a three-dimensional image, and an image calculation unit 34 measures the three-dimensional image.

The image measurement includes (1) a step of determining a cut section edge (a bottom circumferential curve line of a column), (2) a step of determining a minimum diameter, and (3) a step of determining a cut section of a trunk root of the lumber and a cut section of a distal end of the lumber.

The steps described above will be explained in more detail. In the step (1) of determining the cut section edge (the bottom circumferential curve line of the column), a curve having a common plane (that is, even a depth coordinate is continuous) is searched. A closed curve having a closed curve area with a predetermined area (a threshold value) is determined to be a cut section of the lumber.

More specifically, an edge of the lumber has a 90 degree change from a longitudinal direction (a length direction) to a sectional direction of the lumber. Accordingly, it is trying to detect the change. In particular, the lumber is meshed, and a three-dimensional coordinate of a knot of the mesh is continuously determined. A coordinate of a knot on an outer surface of the lumber has a vector changed from a coordinate of a knot on the cut section of the lumber. Through the difference, it is possible to detect the cut section of the lumber.

In the step (2) of determining the minimum diameter, a gravity center of the closed curve forming the edge of the cut section is determined, and 180 straight lines are drawn from the gravity center in a radial direction with an equal interval. A minimum distance between two crossing points between the straight line and the closed curve is determined as the minimum diameter.

In determining the gravity center of the closed area, for example, the closed area is finely divided with a rectangular shape or a triangular shape. Then, a gravity center of each of the shapes is determined to obtain a polygonal shape connecting the gravity centers, so that a gravity center of the polygonal shape is determined as the gravity center of the closed area. Alternatively, when the gravity center of the closed area displayed on a computer screen, color of each pixel having a square shape displayed on the screen is binarized (white is equal to zero, black is equal to one) from an edge of the closed area. First, a sum of all pixels with black is determined. In the next step, pixels with black are added row by row in a vertical direction, so that a row where the number of the pixels with black becomes a half of the sum is determined. Then, pixels with black are added row by row in a horizontal direction, so that a row where the number of the pixels with black becomes a half of the sum is determined. Accordingly, a point where the two rows cross is determined to be the gravity center of the closed area.

In the step (3) of determining the cut section of the trunk root of the lumber and the cut section of the distal end of the lumber, end portions of the lumber in a column shape are determined based on a three-dimensional data.

After the image measurement, the mass volume of the lumber is calculated. A measurement data is stored in a storage device 35 such as a hard disk, so that the measurement data is displayed on a display 16 in detail, or is output on an invoice with a printer 37.

In the embodiment, the computer 30 may include a notebook type ordinary personal computer (referred to as a notebook personal computer 30), in which an input device (a keyboard), a central processing unit (a calculation unit, a control unit), a storage device, and the display 16 as an output device are integrally disposed.

The truck 10 for transporting the lumber has a loading platform 15 at a rear portion thereof for loading the lumber. When the lumber 100 is transported, usually the truck 10 is used.

A grapple device 11 is installed at a rear portion of the loading platform 15 of the truck 10. The grapple device 11 is provided with a boom 12 and an arm 13. The rotational grapple 14 is attached to a distal end portion of the arm 13. The grapple device 11 is a well-known oil pressure type, and a detailed explanation thereof is omitted.

The grapple 14 has markers 140 at four locations at vertexes of a rectangular shape in a plan view. The markers 140 function as common points necessary for composing a photograph of the lumber thus photographed. In this case, it is preferred that the markers 140 are colored in different colors for easy identification.

The operator H sits on a seat 17 to operate the grapple device 11, and the display 16 as the imaging status confirmation device is disposed near the seat 17. When the notebook personal computer 30 is used, the display 16 of the notebook personal computer 30 functions as the imaging status confirmation device. When the display is separated from the personal computer, the image is confirmed on the separate display. Accordingly, the operator H can confirm whether the lumber 100 is in a posture and situated at a position suitable for shooting the photograph thereof when the lumber 100 is photographed.

It is noted that the imaging status confirmation device 16 is suffice to enable the operator H to confirm whether the lumber 100 is in a posture and situated at a position suitable for shooting the photograph thereof when the lumber 100 is photographed. The imaging status confirmation device 16 may be other well-known devices other than the display 16.

In the embodiment, the imaging device 20 captures the photograph of the lumber 100. The imaging device 20 includes three digital cameras 22, a stand 26 for installing the digital cameras 22, and a tripod 24 for supporting the stand 24. The digital cameras 22 constituting the imaging device 20 are situated on the stand 24 disposed on the tripod 24 at positions of vertexes of a regular triangle. A distance between the digital cameras 22 is appropriately adjusted, and is set to 60 cm in the embodiment.

In the embodiment, three digital cameras 22 are used, and the number of the digital cameras 22 is not limited thereto. Further, as long as a relative position of the digital cameras 22 is clearly defined, the positions of the digital cameras 22 are not limited. Further, in the embodiment, the grapple 14 rotates the lumber 100 for obtaining the image thereof. Alternatively, the position of the lumber 100 is fixed, and the imaging device 20 may move to obtain the image. Further, a plurality of imaging devices 20 may be arranged around the lumber 100 to obtain the image.

In the embodiment, the digital cameras 22 are used to obtain the image of the lumber 100. As long as it is possible to obtain the image of the lumber 100, and the computer 30 performs the image processing on the image data, the type of camera is not limited thereto.

A concurrent shutter release controller 28 is disposed between the three digital cameras 22 and the notebook personal computer 30, so that the three digital cameras 22 can shoot the image of the lumber 100 at the same time. As shown in FIG. 1, the notebook personal computer 30, the concurrent shutter release controller 28, and the three digital cameras 22 are connected. Accordingly, when an enter key of the notebook personal computer 30 is pushed, it is possible to release shutters of the digital cameras 22 through the concurrent shutter release controller 28.

After the image data of the lumber 100 obtained with the digital cameras 22 is measured through a sequence of calculation steps (described later), the mass volume of the lumber 100 is calculated. Further, a pattern of the cut section is extracted as an edge surface pattern data through an image processing. The measurement data of the mass volume and the edge surface pattern data are stored in the storage device 35 such as the hard disk. When an invoice is printed at the shooting site, the portable printer 37 outputs the invoice. The measurement data is displayed on the display 16 of the notebook personal computer 30, and it may be able to transmit the measurement data to a lumber market or a lumber sewing plant from the site with a communication device. Further, the measurement data may be output as an electrical data to be readable with other computer.

After the lumber 100 is cut from a mountain woods, the lumber 100 is transported to a transportation side in a pile state. The operator H drives the truck 10, and operates the boom 12 and the arm 13 of the grapple device 11 while sitting in the seat 17. Accordingly, the grapple 14 grapples the lumber 100 from the pile, and moves the lumber 100 in front of the imaging device 20. The grapple 14 can grapple the lumber 100 one by one, or can grapple several lumbers all at once depending on a size of the trunk.

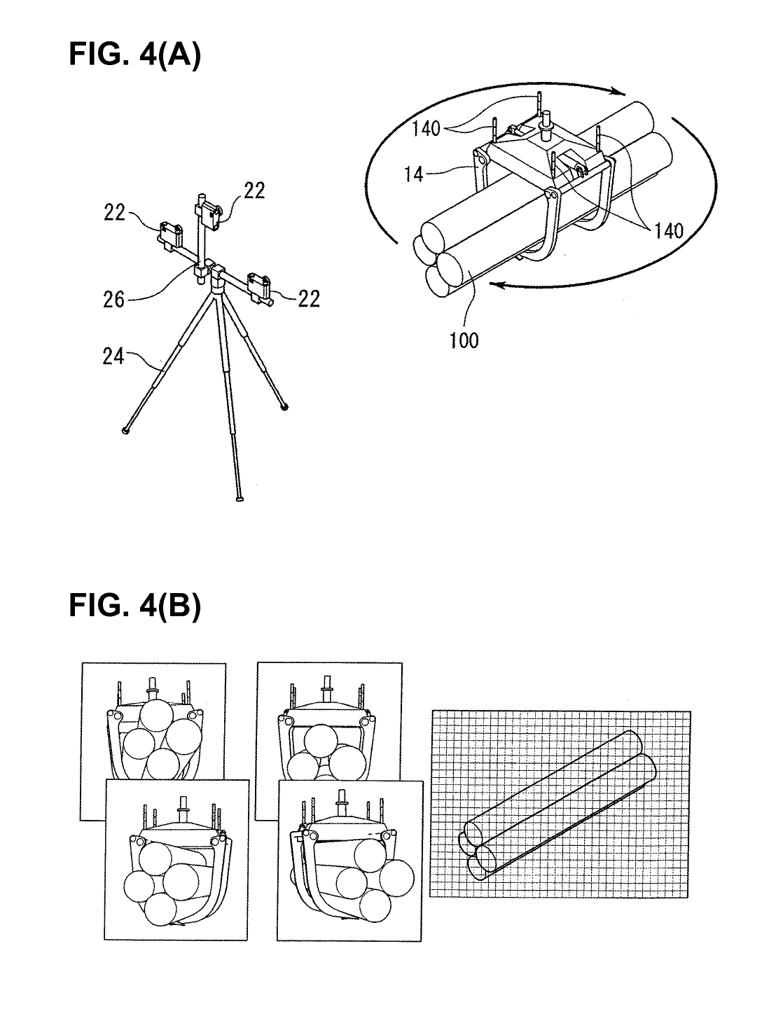

While the rotational grapple 14 grapples the lumber 100, the operator H operates the rotational grapple 14 to rotate, so that the lumber 100 is photographed from four directions, i.e., the distal end cut section side, one side surface side, the trunk root cut section side, and the other side surface side. In the operation, the operator H watches the display 16 of the notebook personal computer 30 to confirm that the lumber 100 is situated at an exact location so that the lumber 100 is accurately photographed from the four directions. Then, the lumber 100 is photographed (refer to FIG. 4(A)).

After the lumber 100 is photographed, the image data thereof is input into the personal computer 30, so that the mass volume calculation unit calculates the mass volume of the lumber 100 through the following steps. It is noted that the steps of calculating the mass volume of the lumber 100 in the following description are just an example in terms of one lumber. When the rotational grapple 14 grapples a plurality of lumbers, the mass volume of the lumber 100 may be measured through the following steps.

1. The step of creating the three-dimensional coordinate model of the lumber 100 (refer to FIG. 4(B)) The method of creating the three-dimensional coordinate model of the lumber 100 has been disclosed in Japanese Patent Publication No. 2006-113001 as a three-dimensional measurement method using a photograph measurement. Further, Kurabo Industries Inc. has been selling software named KURAVES (registered trademark). Accordingly, the method of creating the three-dimensional coordinate model has been well known, and an explanation thereof is omitted.

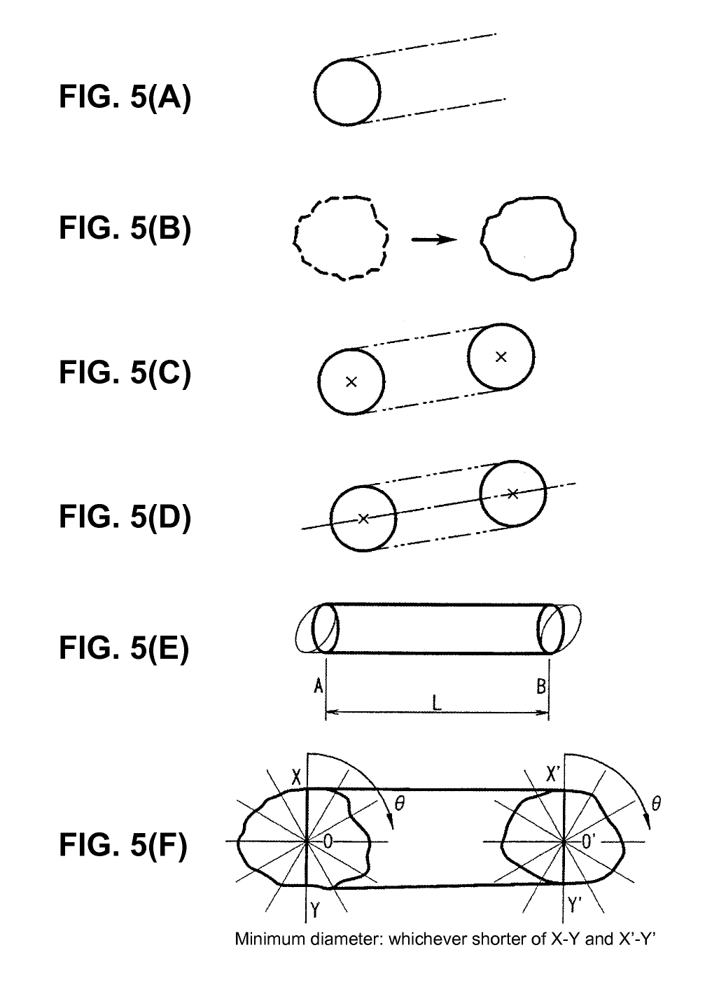

2. The step of calculating the edge cut section of the lumber 100 (the outer contour) (refer to FIG. 5(A)) Among a group of the three-dimensional coordinates obtained in the step 1, the surface coordinates both end portions of the lumber are sampled over a length of 10 cm with an interval of about 5 mm. Accordingly, a group of the coordinates having vectors between the adjacent coordinates in the longitudinal direction changing about 90 degrees in the vertical direction is determined as the edge of the cut section.

3. The step of determining the closed curve area of the edge cut section of the lumber 100 (refer to FIG. 5(B)) The group of the coordinates determined in the step 2 are smoothed (curved line smoothing) as the continuous closed line. In the smoothing, a spline curve is used.

4. The step of calculating the gravity center of the closed area surrounded by the closed curve of the edge cut section of the lumber 100 (refer to FIG. 5(C))

The step is consisted of the following three steps.
a. The closed area is calculated through the rectangular shape with a width of 1 mm in the vertical direction (with crossing points with the closed curve as a longitudinal length), thereby determining the sum of the area.
b. The area is calculated once again in the vertical direction, so that the length (the coordinates in the vertical (Y) direction) when the area becomes the half of the area calculated in the step a. c. Similarly, the area is calculated in the horizontal direction, so that the length (the coordinates in the horizontal (Z) direction) when the area becomes the half of the area calculated in the step a.

5. The step of relatively moving the coordinates One of the gravity centers (x, y, z) is set to be (0, 0, 0) ((x, y, z)=(0, 0, 0)), and the other of the gravity centers (y, z) is set to be (0, 0) ((y, z)=(0, 0)). Accordingly, all of the coordinates are relatively converted.

6. The step of determining the equation of the gravity center line connecting the gravity centers of the both edges (refer to FIG. 5(D))

The equation of the straight line connecting the gravity centers of the both edges obtained in the steps 4 and 5 is determined.

7. The step of calculating the closed curve area of the edge cut section perpendicular to the gravity center line (refer to FIG. 5(E))

The step is consisted of the following three steps.
a. The coordinate at a closest position to the center point of the straight line obtained in the step 6 is determined among the x coordinates of the closed curve area of the edge cut section of the lumber 100 obtained in the step 3 (the coordinate is determined similarly for the both edges).
b. The x coordinate determined in the step a is set to be the x coordinate of the new gravity center (the x′ coordinate of the new gravity center at the other edge).
c. The group of the surface coordinates of the lumber 100 having the x coordinate obtained in the step a, so that the equation of the closed curve is obtained similar to the step 3 (the equation is obtained for the both edges).

8. The step of determining the minimum diameter of the cut section of the lumber 100 (refer to FIG. 5(F))

The distance between the two points of the straight line passing through the new gravity center obtained in the step 7. b. and crossing the closed curve obtained in the step 7. c. is determined. Similarly, while shifting around the gravity center by one degree, the shortest length between the two points crossing the closed curve is determined. Similarly, the shorted length on the opposite side is determined, and the shorter one is adopted.

9. The step of calculating the mass volume of the lumber 100

The mass volume of the lumber 100 is calculated from the length obtained in the step 8 and the length between the gravity centers of the both edges obtained in the step 7. b.

Through the steps described above, it is possible to measure the mass volume of the lumber 100.

After the mass volume of the lumber 100 is calculated as described above, various processes such as the drying process and the sewing process are applied to the lumber 100 after the lumber 100 is cut in the mountain wood. Afterward, the lumber 100 is utilized in various applications such as a pillar or a flooring of a house, a component of furniture, and a construction auxiliary material such as a staging ground and a frame.

In particular, in the wood product such as the house and the furniture, the traceability system of the lumber 100 has been required recently, so that the history of the various processes applied to the lumber 100 from the cutting to the wood product is traced for the purpose of securing the safety and improving the reliability.

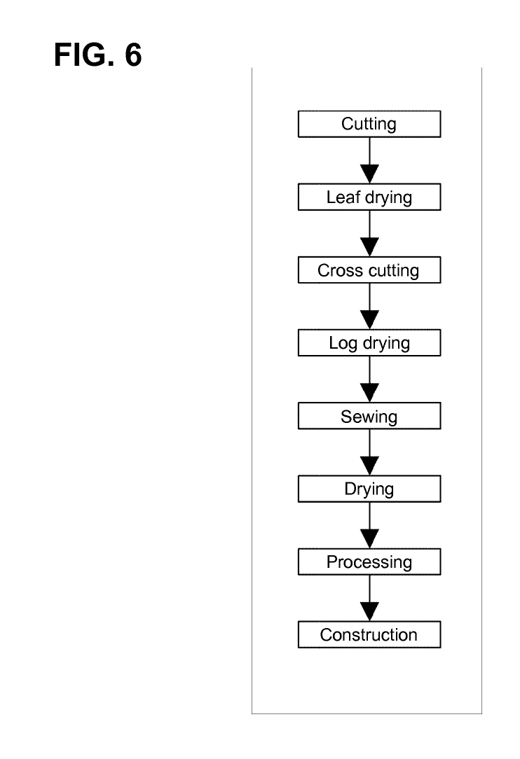

For example, as shown in FIG. 6, when the lumber 100 is used as the pillar of the house, the lumber 100 is cut in the mountain wood, and dried afterward in the mountain wood for a specific period of time (leaf drying). Afterword, the lumber 100 is cut into a specific length (cross cutting), so that the lumber 100 is transported from the mountain wood to the lumber sewing plant in a state of a log thus cut.

In the next step, the lumber 100 is dried in the state of the log outside the lumber sewing plant (log drying). Afterword, the lumber 100 is cut into a specific length (sewing), and the lumber 100 is forcefully dried inside the lumber sewing plant in the cut state (drying). The, the lumber 100 is transported from the lumber sewing plant to a precut plant.

In the next step, the lumber 100 is cut at the precut plant in to a final shape of the pillar. Then, the lumber 100 is transported from the lumber sewing plant to the construction site, so that the lumber 100 is installed as the pillar of the house at the construction site.

As explained above, from when the lumber 100 is cut in the mountain wood to when the lumber 100 is utilized as the pillar of the house at the construction site, the various processes such as the cutting, the leaf drying, the cross cutting, the log drying, the sewing, the drying, the processing, and the construction are applied to the lumber 100.

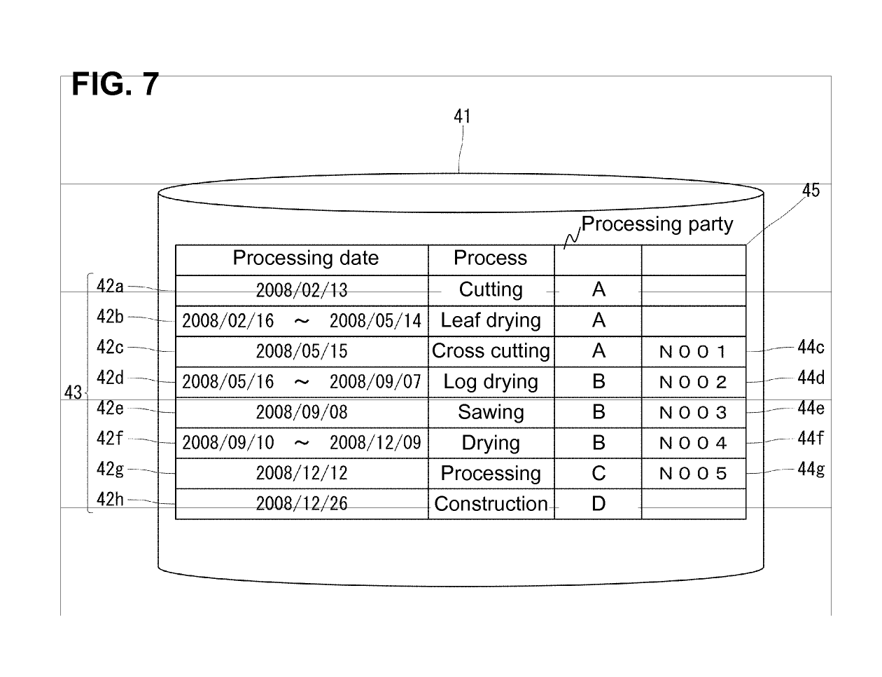

In order to trace and investigate the history of the various processes applied to the lumber 100, in the administration method of the lumber 100, as schematically shown in FIG. 7, processing data 42a to 42h are accumulated to construct history data 43 (a history data construction step). In the processing data 42a to 42h, the various processes applied to the lumber 100, the processing date when the process is applied, a processing party who applies the process, and the mass volume measured through the method described above are combined.

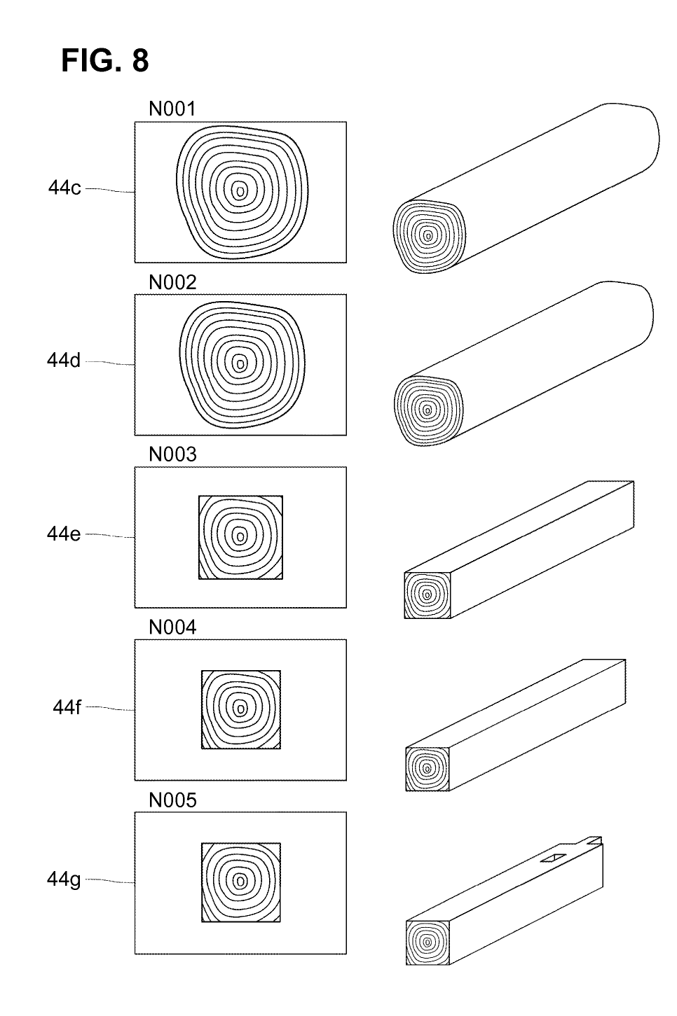

Further, in the administration method of the lumber 100, as schematically shown in FIG. 8, the edge surface pattern appearing on the edge surface of the lumber 100 (the cut section) is photographed after the various processes are applied to the lumber 100. Then, the photographs are used as edge surface pattern data 44c to 44g (the edge surface pattern data creation step). In the next step, the edge surface pattern data 44c to 44g are correlated with the corresponding processing data 42c to 42g of the history data 43, and recorded in a recording medium 41 of the computer (the edge surface pattern data recording step). In the next step, a trace data 45 composed of the history data 43 and the edge surface pattern data 44c to 44g is constructed in the recording medium 41 of the computer (the trace data construction step). In this case, the edge surface pattern of the lumber 100 extracted from the image data photographed when the mass volume is measured is used as the edge surface pattern 44d after the log drying and before the sewing.

Further, in the administration method of the lumber 100, an actual product data is created through photographing the edge surface pattern appearing on the edge surface of the lumber 100 of the actual product when the lumber 100 of the actual product actually utilized as the pillar of the house is traced and investigated to confirm the history of the lumber 100 (the actual product data creation step). In the next step, the actual product data is compared with the edge surface pattern data 44g using the computer to search the edge surface pattern data 44g matching to (or being comparable to) the actual product data (the comparison step). In the next step, the history of the various processes applied to the lumber 100 is displayed according to the history data 43 recorded and correlated with the edge surface pattern data 44g thus searched (the history display step).

As explained above, in the administration method of the lumber 100, in the history data construction step, the history data 43, in which the histories of the various processes applied to the lumber 100 are accumulated, is constructed. Then, in the edge surface pattern data creation step, the edge surface pattern data 44c to 44g, in which the edge surface patterns appearing on the edge surface of the lumber 100 are stored after the various processes are applied, are created. Then, in the edge surface pattern data recording step, the edge surface pattern data 44c to 44g are correlated with the history data 43, and recorded. Then, in the actual product data creation step, the actual product data formed of the edge surface pattern appearing on the edge surface of the actual product of the lumber 100 is created. Then, in the comparison step, the actual product data is compared with the edge surface pattern data 44c to 44g stored in edge surface pattern data recording step. Then, in the history display step, the history of the lumber 100 is displayed according to the corresponding history data 43. The steps described above are performed with the computer.

As explained above, in the administration method of the lumber 100, the history data 43 is correlated with the edge surface pattern data 44c to 44g, in which the edge surface patterns appearing on the edge surface of the lumber 100 are stored after the various processes are applied, and recorded. Further, the edge surface pattern appearing on the edge surface of the actual product of the lumber 100 is compared with the edge surface pattern data 44c to 44g. Accordingly, it is possible to trace the various processes applied to the actual product of the lumber 100.

Accordingly, in the administration method of the lumber 100, even when the lumber 100 is naturally dried outside after being cut, the edge surface pattern of the lumber 100 does not fall off or is not damaged like a barcode or an IC tag. Further, it is possible to compare the edge surface pattern data containing the edge surface pattern after the drying process. Accordingly, it is possible to securely trace and investigate the lumber 100.

It is noted that the embodiment shown in FIGS. 7 and 8 is just an example of the administration method of the lumber 100 according to the present invention. For example, in the embodiment described above, the edge surface pattern of the lumber 100 is photographed to create the edge surface pattern data 44c to 44g only after the specific process (such as the cross cutting, the log drying, the sewing, the drying, and the processing). Alternatively, the edge surface pattern of the lumber 100 may be photographed after all of the processes.

Further, in the embodiment described above, the edge surface pattern of the lumber 100 is photographed to create the edge surface pattern data 44c to 44g. As a result, the edge surface pattern data 44c to 44g contain information including an annual growth ring, a crack, an insect bite, and a scar appearing on the edge surface of the lumber 100. In this case, the photograph may be processed through an image processing to extract only the annual growth ring of the edge surface of the lumber 100 as the edge surface pattern. The extracted data is used as the edge surface pattern data 44c to 44g.

When the annual growth ring of the edge surface of the lumber 100 is used as the edge surface pattern as described above, the pattern of the annual growth ring is specific to the lumber 100, and it is difficult to artificially fabricate the pattern of the annual growth ring. Accordingly, it is possible to improve the reliability of the traceability and the investigation of the lumber 100.

What is claimed is:

1. An administration method of a lumber, comprising the steps of:
photographing an outer appearance of the lumber to obtain an image data;
creating a three-dimensional coordinate model of the lumber from the image data;
obtaining a minimum diameter and a length of the lumber from the three-dimensional coordinate model; and
calculating a mass volume of the lumber.

2. The administration method of the lumber according to claim 1, wherein, in the step of photographing the outer appearance of the lumber, said outer appearance of the lumber is photographed when a rotational grapple provided in a transportation vehicle grapples and rotates the lumber to carry the lumber in an transportation vehicle or unload the lumber from the transportation vehicle.

3. The administration method of the lumber according to claim 1, further comprising the steps of:
extracting an edge surface pattern appearing on an edge surface of the lumber from the image data;
recording the edge surface pattern appearing on the edge surface of the lumber to create an edge surface pattern data after various processes are applied to the lumber;
accumulating the various processes to create a history data;
correlating the edge surface pattern data with the history data; and
comparing the edge surface pattern appearing on the edge surface of the lumber with the edge surface pattern data so that it is possible to trace and investigate the history of the various processes applied to the lumber.

4. The administration method of the lumber according to claim 3, wherein, in the step of extracting the edge surface pattern, an annual growth ring of the edge surface of the lumber is used as the edge surface pattern.
